(19) United States
(12) Patent Application Publication
(10) Pub. No.: US 2010/0200261 A1
(43) Pub. Date: Aug. 12, 2010

(54) TERMINAL FOR ELECTRICAL CONNECTION AND METHOD FOR ASSEMBLY THEREOF

(75) Inventor: David Boutot, Saint-Cyr-Les-Champagnes (FR)

Correspondence Address: YOUNG & THOMPSON, 209 Madison Street, Suite 500, Alexandria, VA, 22314, US

(73) Assignee: MECATRACTION, Arnac Pompadour (FR)

(21) Appl. No.: 12/675,976

(22) PCT Filed: Sep. 2, 2008
(86) PCT No.: PCT/FR2008/051556

§ 371 Date: Mar. 2, 2010

(30) Foreign Application Priority Data
Sep. 5, 2007 (FR) 0757365

(51) Int. Cl. H02G 15/22; H01R 43/048

(52) U.S. Cl. 174/19; 29/857; 29/863

(57) ABSTRACT

The terminal for electrical connection includes a pin (2) with a recess (9), partially filled with a contact grease, to accommodate the end of an electric cable (22) and including a crimping section (5) designed to be radially deformed and further includes a stopper (15) to retain the grease (14) in the recess (9). The stopper has a transverse membrane (16) designed to be broken by the electric cable (22) on insertion thereof into the recess (9) and at least one portion arranged in the crimping section (5) such that the stopper (15) leads to the sealing of the connection after crimping. The grease (14) is arranged between the base (12) of the recess (9) and the membrane (16). The assembly method includes the step of breaking the transverse membrane (16) by element of the end of the electric cable (22) on insertion thereof in the recess (9).

The invention relates to the general field of electrical connection technology.

It relates more particularly to a terminal for electrical connection.

It is known that there are terminals comprising a shank provided with a crimping portion connected to a portion for connection of a terminal element with which the terminal is designed to interact.

Known in particular from document FR 2 620 579 is a terminal the shank of which receives, in the recess that it has, the end of an electric cable, this recess being partially filled with contact grease in order to enhance the cable/terminal electrical connection. The terminal also comprises an annular seal in order to seal the cable/terminal connection.

On insertion of the cable into the recess, the cable sinks into the grease and then the operator crimps the terminal.

The object of the invention is to improve this type of terminal, both in manufacture and in use.

For this purpose, the invention proposes a terminal for electrical connection, comprising a shank having a recess partially filled with a contact grease, designed to receive the end of an electric cable and comprising a crimping portion suitable for being deformed radially, characterized in that said terminal also comprises a stopper for keeping said grease in said recess, which has a transverse membrane suitable for being torn by the electric cable when it is inserted into said recess and which has at least one portion placed in said crimping portion, said grease being placed between the bottom of said recess and said membrane.

Therefore the stopper, while keeping the grease in the recess before the connection, remains in place on insertion of the cable, its membrane being simply torn by the end of the cable so that it is not necessary to remove the stopper, which provides a time-saving for the operator. And the stopper is placed in a zone of the shank that is crimped so that, by being held between the cable and the walls of the crimped shank, the stopper can help with the sealing of the connection (between the terminal and the cable).

According to features of application that are particularly simple and convenient both for manufacture and for use:
said recess has a tubular shape; and/or
said stopper has a tubular portion, the thickness of said membrane being less than that of said tubular portion; and/or
said stopper has a first end situated facing said bottom and a second end situated at said opening that said recess comprises opposite to said bottom; and/or
said membrane is situated on the side of said first end; or
said membrane is situated on the side of said second end; or
said membrane is situated in an intermediate position between said first end and said second end; and/or
said stopper comprises an annular rim placed, outside said recess, against the free end of said shank; and/or
said stopper is made of silicone; and/or
said terminal is made of aluminum; and/or
said grease comprises an oil and zinc balls; and/or
the terminal also comprises a flat portion connected to the shank, said flat portion comprising a passageway hole for the stem of a terminal element with which said terminal is designed to interact; and/or
said shank comprises, between said bottom and said crimping portion, a second crimping portion designed to be deformed radially and to accommodate the end of said electric cable.

The invention also proposes a method for assembling a terminal for electrical connection and an electric cable, characterized in that it comprises the step of taking a terminal as described above, the step of taking an electric cable the end of which is designed to be received in said recess and the step of tearing said transverse membrane that said stopper comprises by means of said end of said electric cable when it is inserted into said recess.

According to the features of application that are particularly simple and convenient both for manufacture and for use:
this method also comprises the step of crimping said crimping portion at least at said portion of said stopper placed in said crimping portion;
in said crimping step, said crimping portion is crimped at said stopper; and/or
since said shank comprises between said bottom and said crimping portion a second crimping portion, this method also comprises the step of crimping said second crimping portion, the latter taking place before the step of crimping said crimping portion.

The features and advantages of the invention will emerge from the following description, given as a preferred, but nonlimiting, example with reference to the appended drawings in which:

FIG. 1 is a view in section of a terminal according to the invention and of the cable ready to be inserted into this terminal;

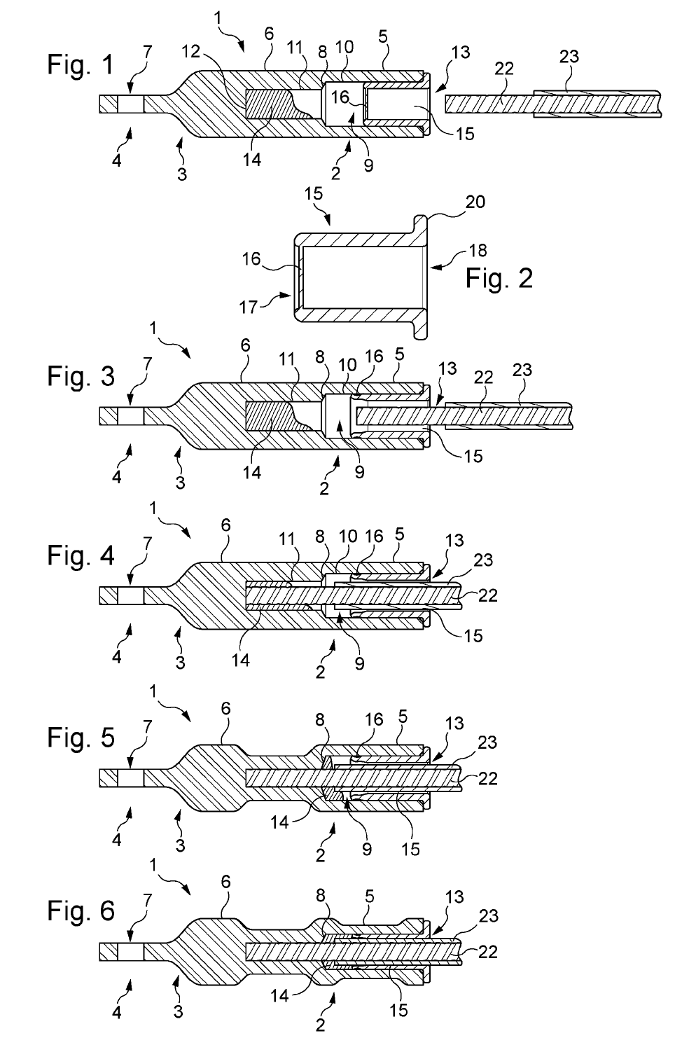

FIG. 2 is a view in section of the stopper illustrated in FIG. 1;

FIG. 3 is a view in section similar to that of FIG. 1, the cable being partially inserted, up to the torn membrane of the stopper;

FIG. 4 is a view similar to that of FIG. 3, the cable being completely inserted into the recess of the terminal;

FIG. 5 is a view similar to that of FIG. 4, the terminal being crimped at the end of the cable;

FIG. 6 is a view similar to that of FIG. 5, the terminal also being crimped at the stopper;

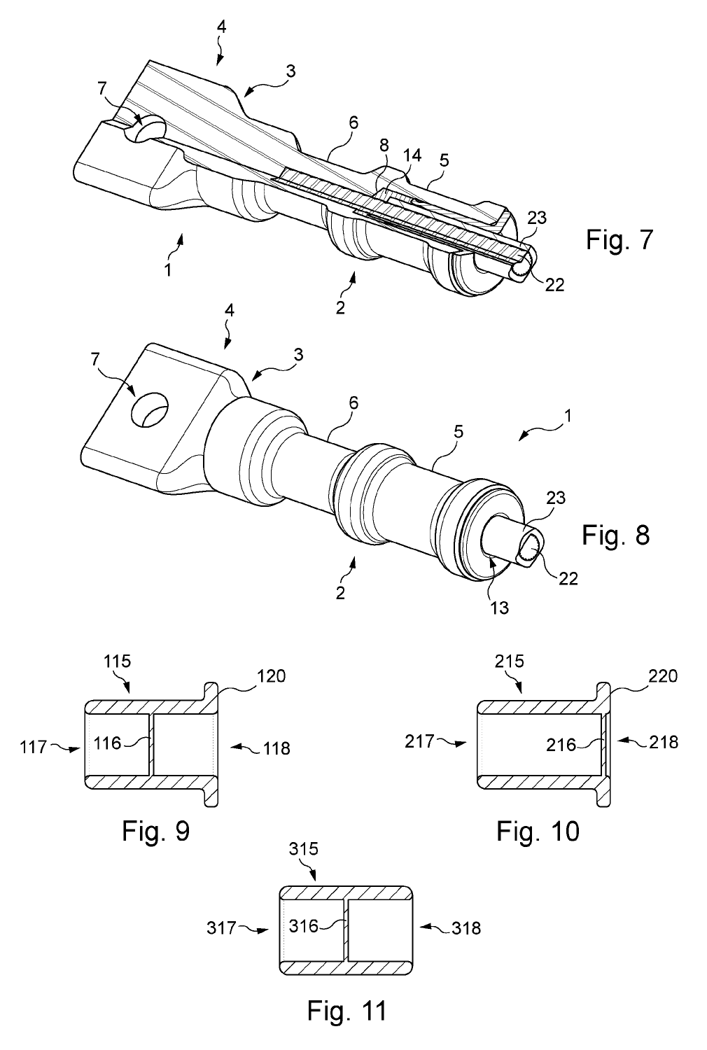

FIG. 7 is a view in perspective of the terminal and of the cable of FIG. 6 with a terminal portion cut away;

FIG. 8 is a view similar to that of FIG. 7, the terminal being shown in its entirety;

FIGS. 9 and 10 are views in section of two variants of the stopper of FIG. 2, with respectively the membrane situated in an intermediate position and the membrane situated on the side of the second end of the stopper;

FIG. 11 is a view in section of another variant of a stopper for a terminal according to the invention with no rim at the free end and with a membrane positioned in an intermediate position.

The terminal 1 shown in the figures comprises a shank 2 connected by a transition portion 3 to a flat connection portion 4.

The terminal 1 is made of aluminum.

The shank 2 is of generally tubular shape and comprises a first sealing cylindrical section 5 which forms a first crimping portion and a cylindrical connection section 6 which forms a second crimping portion.

The flat portion 4 is a connecting pad which has a generally parallelepipedal shape with a free end in a flattened arc of a circle. It has, toward the free end, an orifice 7 suitable for receiving a threaded stem (not shown) belonging to a connection terminal element for example furnished with a supporting collar. This collar is suitable for receiving the lower face of the flat portion 4. In order to ensure the electric contact between the terminal element and the terminal 1, the flat portion 4 is gripped between the supporting collar and a nut screwed onto the threaded stem.

The terminal 1 is now described in its state before crimping.

The shank 2 has a constant external diameter over the whole of its length while the transition portion 3 has a characteristic shape making it possible to connect the flat shape of the portion 4 to the cylindrical shape of the connection section 6 of the shank 2.

The sealing section 5 has a tubular wall the internal diameter of which is constant over the whole of its length while the connection section 6 is tubular in the extension of the sealing section 5 only over a portion of its length. The rest of the section 6 (on the side of the flat portion 4) is solid. In the zone in which the section 6 is tubular, its internal diameter is less than the internal diameter of the section 5 so that the wall of the section 6 is thicker there than the wall of the sealing section 5. A bevel 8 forming an annular ramp toward the section 6 extends between the sections 5 and 6 in order to connect these two sections with different internal diameters.

Therefore the shank 2 has a cylindrical recess 9 a first portion 10 of which extends to the sealing section 5 and a second portion 11 extends to the connection section 6. The recess 9 has a bottom 12 and an opening 13 opposite to the bottom 12.

The second portion 11 is partially filled with contact grease 14 comprising oil and zinc balls. This grease 14 makes it possible to break the alumina film which is formed on the surface of the wall of the recess 9, exposed to the air.

The recess 9 and more precisely its opening 13 is closed off by a silicone stopper 15 (FIG. 2). According to another embodiment, the stopper is made of a material other than silicone while having properties in terms of seal. This stopper 15 is tubular and has an external diameter corresponding to the internal diameter of the section 5. At one of its ends 17, it has a tearable membrane 16 which closes at this end 17 the stopper 15. At its other end 18 opposite to the end 17, the stopper 15 has an annular rim 20 extending in a plane parallel to that in which the membrane 16 extends.

The stopper 15 is placed in the terminal 1 through the opening 13 so that the rim 20 is positioned against the free end of the tubular wall of the section 5. The membrane 16 is then sunk inside the first portion 10 with the lateral surface of the stopper 15 in contact with the lateral surface of a portion of the contour of the first portion 10.

The grease 14 placed in the second recess portion 11 is situated between the bottom 12 and the membrane 16. In this position, this grease 14 cannot flow out of the recess 9. No foreign body can enter the recess 9 and notably the second portion 11.

The stopper 15 has a double property: on the one hand, retaining the grease and preventing the intrusion of foreign bodies and, on the other hand, sealing. Sealing means may actually be necessary for these terminals in order to prevent water penetrating to the connection section which could damage the quality of the connection because, in the event of humidity or the presence of water on the cable, the latter can travel along the cable by capillarity.

With reference to the seal, the presence of the stopper (between the shank and the cable and between the grease and the outside) is a first factor that contributes to the seal. The material of the stopper is another factor and the silicone contributes particularly effectively to the sealing function. Another choice of material is possible for the stopper.

With reference to FIGS. 1 and 3 to 6 the insertion of a cable into the terminal 1 and the crimping of the latter is now described.

The terminal 1 is suitable for interacting with an aluminum cable 22 covered on its surface by an insulating layer 23. The end of the cable 22 is stripped, that is to say that there is no insulation 23 here. The cable 22 is made of aluminum.

The cable 22 is inserted with its stripped end at the front into the recess 9 through the opening of the stopper up to its membrane 16. By continuing insertion, the membrane 16 is torn under the effect of the pressure of the cable 22 (FIG. 3). The cable 22 is then inserted further until the latter comes into contact with the grease 14 and then touches the bottom 12 of the recess 9 (FIG. 4). In this state of cooperation of the terminal 1 and the cable 22, the stripped portion of the cable 22 has passed through the stopper 15. This stopper 15 is then facing only the insulation 23 of the cable 22.

On contact with the grease 14, the alumina layer (not shown), which has formed on the surface of the stripped portion of the cable 22, reacts.

With reference to FIG. 5, the connection section is crimped in a manner known per se (and which will not be described in greater detail here). The tubular wall of the section portion 6 corresponding to the recess portion 11 comes into contact with the stripped end of the cable 22. The grease 14 is largely expelled toward the first recess portion 10, a thin layer of grease 14 being able to remain between the surface of the end of the cable 22 and the internal surface of the section portion 6.

Then the sealing section 5 is crimped so that the lateral wall of the stopper 15 is pressed between the lateral wall of the sealing section 5 and the cable 22 and more particularly against its layer of insulation 23 so that the seal is ensured. The grease 14 occupies the space left free between the cable 22 or the insulation 23, the stopper 15, the bevel 8 and the lateral surface of the second recess portion 11. The volume of grease placed in the recess 9 is chosen to correspond with the free volume of the recess 9 after insertion of the cable 22 and crimping.

According to variant embodiments of the stopper, it is desired that the pieces of the membrane, once torn, remain located at the stopper so that the latter is placed upstream of the first end. The stopper 115 shown in FIG. 9 comprises a membrane 116 placed in an intermediate position halfway between the ends 117 and 118 while the membrane 216 of the stopper 215 is placed at the second end 218.

According to a variant shown in FIG. 11, the stopper 315 has no rim.

According to a variant to the embodiment, the stopper is shorter than that shown in the figures.

According to variants of the embodiment, the stopper is made of a material other than silicone and/or the material of the cable and of the terminal is another material suitable for this type of connection and/or the grease comprises no zinc balls.

According to another variant, the membrane has a shape that is not flat, for example concave in the direction of insertion of the cable into the recess.

According to yet another embodiment not shown, the connection pad has a different shape, for example tubular.

Variant embodiments of the terminal may be envisaged without nevertheless departing from the context of the invention. Notably the connection portion is suited to the terminal element in question or else the outer shape of the terminal and in particular its crimped zones may have a different profile.

1. Terminal for electrical connection, comprising a shank having a recess (9) partially filled with a contact grease, designed to receive the end of an electric cable (22) and comprising a crimping portion (5) suitable for being deformed radially, characterized in that said terminal also comprises a stopper (15, 115, 215, 315) for keeping said grease (14) in said recess (9), which has a transverse membrane (16, 116, 216, 316) suitable for being torn by the electric cable (22) when it is inserted into said recess (9) and which has at least one portion placed in said crimping portion (5), said grease (14) being placed between the bottom (12) of said recess (9) and said membrane (16, 116, 216, 316).

2. Terminal according to claim 1, characterized in that said recess (9) has a tubular shape.

3. Terminal according to claim 2, characterized in that said stopper (15, 115, 215, 315) has a tubular portion, the thickness of said membrane (16, 116, 216, 316) being less than that of said tubular portion.

4. Terminal according to claim 1, characterized in that said stopper (15, 115, 215, 315) has a first end (17, 117, 217, 317) situated facing said bottom (12) and a second end (18, 118, 218, 318) situated at said opening (13) that said recess (9) comprises opposite to said bottom (12).

5. Terminal according to claim 4, characterized in that said membrane (16) is situated on the side of said first end (17).

6. Terminal according to claim 4, characterized in that said membrane (216) is situated on the side of said second end (218).

7. Terminal according to claim 4, characterized in that said membrane (116, 316) is situated in an intermediate position between said first end (117, 317) and said second end (118, 318).

8. Terminal according to claim 2, characterized in that said stopper (15, 115, 215) comprises an annular rim (20, 120, 220) placed, outside said recess (9), against the free end of said shank (2).

9. Terminal according to claim 1, characterized in that said stopper (15, 115, 215, 315) is made of silicone.

10. Terminal according to claim 1, characterized in that it is made of aluminium.

11. Terminal according to claim 1, characterized in that said grease (14) comprises an oil and zinc balls.

12. Terminal according to claim 1, characterized in that it also comprises a flat portion (4) connected to the shank (2), said flat portion (4) comprising a passageway hole (7) for the stem of a terminal element with which said terminal is designed to interact.

13. Terminal according to claim 1, characterized in that said shank (2) comprises, between said bottom (12) and said crimping portion (5), a second crimping portion (6) designed to be deformed radially and to accommodate the end of said electric cable (22).

14. Method for assembling a terminal for electrical connection and an electric cable, characterized in that it comprises the step of taking a terminal according to claim 1, the step of taking an electric cable (22) the end of which is designed to be received in said recess (9) and the step of tearing said transverse membrane (16, 116, 216, 316) that said stopper (15, 115, 215, 315) comprises by means of said end of said electric cable (22) when it is inserted into said recess (9).

15. Method according to claim 14, characterized in that it also comprises the step of crimping said crimping portion (5) at least at said portion of said stopper (15, 115, 215, 315) placed in said crimping portion (5).

16. Method according to claim 15, characterized in that, since said shank (2) comprises between said bottom (12) and said crimping portion (5) a second crimping portion, it also comprises the step of crimping said second crimping portion (6), the latter taking place before the step of crimping said crimping portion (5).

17. Terminal according to claim 2, characterized in that said stopper (15, 115, 215, 315) has a first end (17, 117, 217, 317) situated facing said bottom (12) and a second end (18, 118, 218, 318) situated at said opening (13) that said recess (9) comprises opposite to said bottom (12).

18. Terminal according to claim 3, characterized in that said stopper (15, 115, 215, 315) has a first end (17, 117, 217, 317) situated facing said bottom (12) and a second end (18, 118, 218, 318) situated at said opening (13) that said recess (9) comprises opposite to said bottom (12).

19. Terminal according to claim 3, characterized in that said stopper (15, 115, 215) comprises an annular rim (20, 120, 220) placed, outside said recess (9), against the free end of said shank (2).

20. Terminal according to claim 4, characterized in that said stopper (15, 115, 215) comprises an annular rim (20, 120, 220) placed, outside said recess (9), against the free end of said shank (2).
